(19) United States
(12) Patent Application Publication
(10) Pub. No.: US 2005/0275333 A1
(43) Pub. Date: Dec. 15, 2005

(54) White light illumination device and method of manufacturing the same

(76) Inventors: Ru-Shi Liu, Hsinchu Hsien (TW); Liang-Sheng Chi, Yun-Lin Hsien (TW); Hung-Yuan Su, Taipei City (TW)

Correspondence Address: BIRCH STEWART KOLASCH & BIRCH, PO BOX 747, FALLS CHURCH, VA, 22040-0747, US

(21) Appl. No.: 10/865,895

(22) Filed: Jun. 14, 2004

(51) Int. Cl. H01J 1/62; H01J 63/04

(52) U.S. Cl. 313/486

(57) ABSTRACT

The present invention describes an apparatus and method for manufacturing a white light-emitting diode (LED) using a powder with characteristics of fluorescence to achieve a high-luminosity white LED. The LED emitting ultraviolet light is used as an excitation source, which excites a first powder with blue-green light, and a second powder with orange light. After that, a white light is produced by blending blue-green and orange light with the principle of complementary colors. For achieving the high-luminosity white LED, the invention adopts a suitable LED to be the excitation source with a suitable blending proportion. On the other hand, the implementation of the fluorescent powder with blue-green light can be modulated using a metal ion in the host lattice to change the ligard field of the crystal.

### BACKGROUND OF THE INVENTION

1. Field of the Invention

The present invention relates to a white light illumination device and a method for producing the same. It particularly relates to a white light illumination device and a method for producing the same that uses two fluorescent materials and an ultraviolet excitation light source to achieve white light with high-luminosity according to the principle of complementary color.

2. Description of Prior Art

White light is a mixture of multiple colors of light, including at least two kinds of light with different wavelengths. For instance, the viewer can perceive the mixture of red, blue and green light or the mixture of blue and yellow as white light. Therefore, a white light illumination device is attainable according to the principle as above described.

Conventionally, there are many methods of obtaining a white light illumination device. The first conventional method is to use three light emitting diodes (LEDs) to provide red, green and blue light by controlling a corresponding driving current respective to each LED. One of the three LEDs is made of InGaAlP, and the other two are made of GaN. The three LEDs are packaged in a lamp, and a lens is used to mix light from the three LEDs to generate white light.

The second conventional methods is similar to the first conventional methods, the difference therebetween is that the second methods only uses two LEDs to provide blue and yellow-green light for producing white light. The two LEDs include one made of GaN and another made of GaP. At present, the light emission efficiency of the described conventional methods has achieved 20 lm/w. However, the conventional methods suffer from the following disadvantages. White light can no longer be produced if one of the LEDs fails. Moreover, a different controlling circuit responding to each LED is necessary, which is expensive.

The third conventional method was developed by Japan Nichia Chemical Industries, Ltd. in 1996, and provides a white light illumination device using a blue light-emitting diode made of an InGaN semiconductor, and a yttrium aluminum garnet (“YAG:Ce”) fluorescent material, which emits yellow light. The mixture of these blue and yellow emission lights also can be perceived as white light by an observer. Although the light emission efficiency of this kind of white light illumination device is slightly lower than that of the first and second conventional methods, it can greatly reduce fabrication cost because only one LED chip is needed. Furthermore, fluorescent material technology improves daily. Thus, a white light illumination device of this method has been available on the market.

However, the second and the third conventional methods utilize the principle of complementary colors to generate white light, of which the spectrum distribution is not as continuous as that of natural sunlight in the visible portion of the spectrum. In result, the white light generated by these methods has a lower color saturation, and is only suitable for simple illumination purposes. Recently, an ultraviolet light-emitting LED has been developed, which can be used to excite conventional fluorescent material to generate white light. Furthermore, the ultraviolet light emitting LED has a valuable merit of low power consumption. Thus, a white light illumination device formed by this method can very likely be a substitute for conventional lamp or fluorescent lamp in the future. Conventional white light illumination device commonly uses three or more kinds of fluorescent materials in order to improve color rendering characteristics. However, to obtain a perfect white light with many kinds of fluorescent materials, the following conditions must be met. First, a chosen excitation light should be completely absorbed by the fluorescent materials, and the difference between the light absorption coefficient of each fluorescent material should be as small as possible, Likewise, the light energy transferring efficiency of the fluorescent materials preferably should be as close as possible. Therefore, the above conditions greatly limit number of fluorescent materials that can be utilized, causing difficulties in choosing suitable fluorescent materials.

Typically, a conventional light color modulation method is implementing by adding or mixing two kinds of impurity ions as active centers at the same time. A fluorescent material capable of radiating two kinds of wavelengths light is thus obtained. Moreover, different colors of light can be obtained by adjusting the proportions of these active centers. However, most impurity ions need different excitation wavelengths, so the feasibility of this method is not as high as expected.

Therefore, the present invention provides an improved white light illumination device and a manufacturing method for the same that can overcome or at least reduce the disadvantages set forth above.

### SUMMARY OF THE INVENTION

In accordance with one aspect of the present invention, there is provided a white light illumination device that comprises a light-emitting diode capable of emitting ultraviolet light, a first fluorescent powder excited by the ultraviolet light from the light-emitting diode and emitting blue-green fluorescent light having a peak emission wavelength of about 470 to about 500 nm, and a second fluorescent powder being excited by the ultraviolet light from the light-emitting diode and emitting orange fluorescent light having a peak emission wavelength of about 570 to about 600 nm. A chemical formula of the first fluorescent powder is (Ba_{1-x-y}EuₓSr_{y})MgAl₁₀O₁₇, where 0<x≦1, 0≦y≦1; and a chemical formula of the second fluorescent powder is (Ca,Eu,Mn)(PO₄)₃Cl. The blue-green and the orange fluorescent lights combine to produce white light.

In accordance with another aspect of the present invention, a method of making a white light illumination device is provided and comprises steps described as follows. An ultraviolet light source is provided. A first fluorescent powder is synthesized and emits a blue-green light having a peak wavelength of about 470 to about 500 nm by excitation with ultraviolet light emitted from the ultraviolet light source. A second fluorescent powder is synthesized and emits an orange light having a peak wavelength of about 570 to about 600 nm by excitation with ultraviolet light emitted from the ultraviolet light source. The first and second fluorescent powders are blended in a predetermined proportion.

### BRIEF DESCRIPTION OF THE DRAWINGS

Other objects, advantages, and novel features of the present invention will become more apparent from the following detailed description when taken in conjunction with the accompanying drawings, in which:

FIG. 1 is a schematic view showing the 5d orbital of Eu²⁺ ions in a separated state under the effect of a crystal field;

FIG. 2 shows an excitation spectrum and an emission spectrum of a fluorescent powder (Ba_{1-x-y}EuₓSr_{y}) MgAl₁₀O₁₇ (x=0.15; y=0−0.85) according to an embodiment to the present invention;

FIG. 3 is a chromaticity diagram showing the color coordinate points of a fluorescent powder (Ba_{1-x-y}EuₓSr_{y}) MgAl₁₀O₁₇ (x=0.15; y=0−0.85) according to an embodiment of the present invention;

FIG. 4 shows an excitation spectrum and an emission spectrum of an orange fluorescent powder (Ca,Eu,Mn)(PO₄)₃Cl according to an embodiment to the present invention;

FIG. 5 is a chromaticity diagram showing the color coordinate points of an orange fluorescent powder (Ca,Eu,Mn)(PO₄)₃Cl according to an embodiment of the present invention; and

FIG. 6 shows that the corresponding color coordinate points of the first and the second fluorescent powders of the present invention are connected together with a dashed line in a chromaticity diagram, this dashed line passing through a white region of the chromaticity diagram.

### DETAILED DESCRIPTION OF THE INVENTION

A white light illumination device of the present invention comprises a light source capable of emitting ultraviolet light, a first fluorescent powder and a second fluorescent powder. The ultraviolet light emitted by the light source excites the first fluorescent powder, causing it to radiate blue-green fluorescent light having a peak emission wavelength of about 470 to about 500 nm. The ultraviolet light emitted by the light source excites the second fluorescent powder, causing it to radiate orange fluorescent light having a peak emission wavelength of about 570 to about 600 nm. When the blue-green fluorescent light and the orange fluorescent light blend together, the viewer perceives the mixture of blue-green and orange light as white light.

The first fluorescent powder can be made of (Ba_{1-x-y}EuₓSr_{y})MgAl₁₀O₁₇, where 0<x≦1, 0≦y≦1, and the second fluorescent powder can be made of (Ca,Eu,Mn)(PO₄)₃Cl.

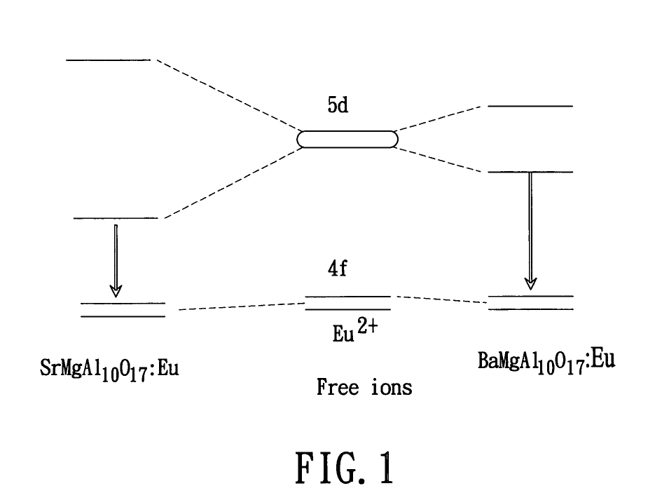

In order to make the peak emission wavelength of the first fluorescent powder (Ba_{1-x-y}EuₓSr_{y})MgAl₁₀O₁₇ shift toward the blue, the present invention implements color modulation of the fluorescent light by the principal that a radius of a metal ion in a host crystal lattice can change the force of a crystal lattice field. The 4f orbital of a Eu²⁺ ion separates into ²F_{5/2}and ²F_{7/2} states due to the effect of spin-orbital coupling, and the 5d orbital is also split by the effect of the crystal lattice field. Referring to FIG. 1, when a metal ion with a smaller ion radius is doped into (Ba_{1-x-y}EuₓSr_{y})MgAl₁₀O₁₇, it reduces the electrical expulsive force, and the splitting of the 5d orbital therefore declines. On the contrary, after being excited, energy of the Eu²⁺ ion that returns to the 4f orbital from the lower energy state 5d orbital is increased. As a result, the wavelength of light experiences a blue shift.

Furthermore, the present invention replaces Ba²⁺ ion in the conventional yellow fluorescent powder (Ba_{1-x-y}EuₓSr_{y})MgAl₁₀O₁₇ with an Sr²⁺ ion. To a substitutional solid solution, the adulterate concentration of its heterogeneous ions mainly depends on the structural difference between its resultant and primary reactants. Both BaMgAl₁₀O₁₇ and SrMgAl₁₀O₁₇ have a same spatial group symmetry of P6₃/mmc, and both the Sr²⁺ ion and Ba²⁺ ion thereof are in D₃h symmetry. Thus, it can be deduced that the Sr²⁺ ion has excellent solubility in the BaMgAl₁₀O₁₇. The Sr²⁺ ion has a relatively bigger electron cloud expansion effect compared with Ba²⁺ ion, and makes the wavelength of light generate a red shift. Thus, in general, when the Ba²⁺ ion is replaced with the Sr²⁺ ion, the peak wavelength of light emitted from the Eu²⁺ ion when transitioning from the 4f orbital to the 5d orbital should shift from 450 nm (y=0.00) to 480 nm (y=0.85).

The first and the second fluorescent powders of the present invention can be excited by the same excitation light, and radiate blue-green light (from 470 nm to 500 nm) and orange light (from 570 nm to 600 nm), respectively. Accordingly, the white light illumination device of the present invention can be made by blending the first and the second fluorescent powders in suitable proportions.

A preferred fabrication method of the white light illumination device of the present invention includes the following process. An ultraviolet light source is provided, and the first fluorescent powder (Ba_{1-x-y}EuₓSr_{y})MgAl₁₀O₁₇, for example, (Ba_{0.425}Eu_{0.15}Sr_{0.425})MgAl₁₀O₁₇, is synthesized. The second fluorescent powder (Ca,Eu,Mn)(PO₄)₃Cl is synthesized, and then the first and second fluorescent powders are blended in predetermined proportions. The first fluorescent powder and the second fluorescent powder are produced by a solid reaction method or a chemical synthesizing method, such as a citrate gel method or a co-precipitation method, and the like.

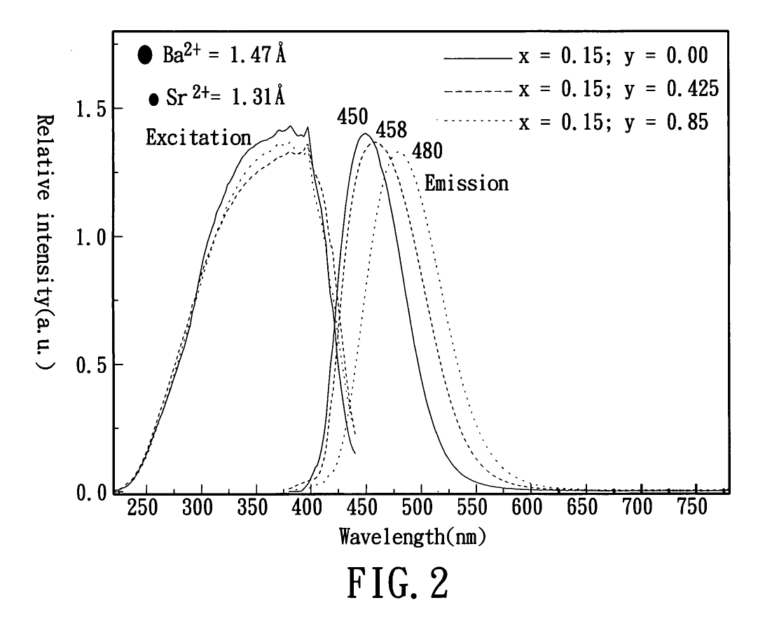

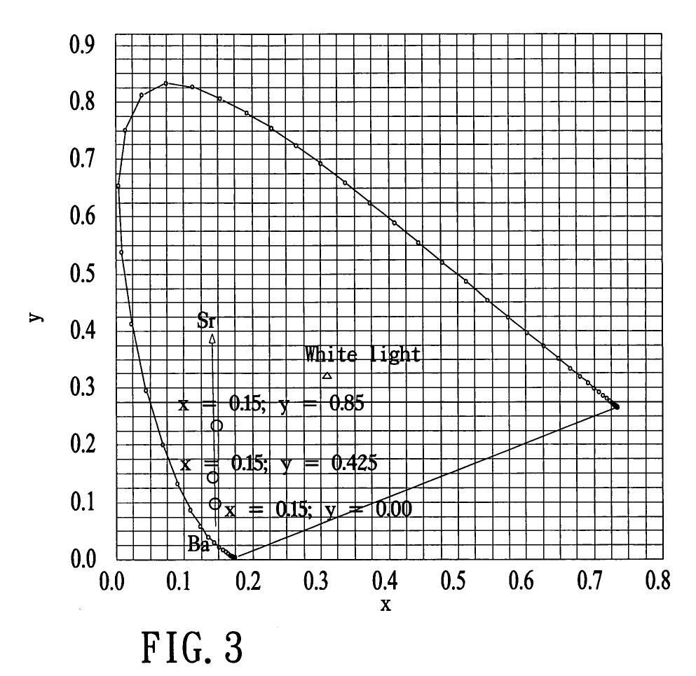

Referring to FIG. 2, a ultraviolet light with 396 nm wavelength as an excitation light source is used to measure the light emission spectrum of a fluorescent material Sr_{0.85}Eu_{0.15}MgAl₁₀O₁₇, which is one example of the first material fluorescent material (Ba_{1-x-y}EuₓSr_{y})MgAl₁₀O₁₇, where 0<x≦1, 0≦y≦1. As can be seen, the fluorescent material Sr_{0.85}Eu_{0.15}MgAl₁₀O₁₇ can generate blue-green light by excitation. The light emission spectrum of the fluorescent material Sr_{0.85}Eu_{0.15}MgAl₁₀O₁₇ is represented with color coordinate points x and y in a C.I.E chromaticity diagram as shown in FIG. 3.

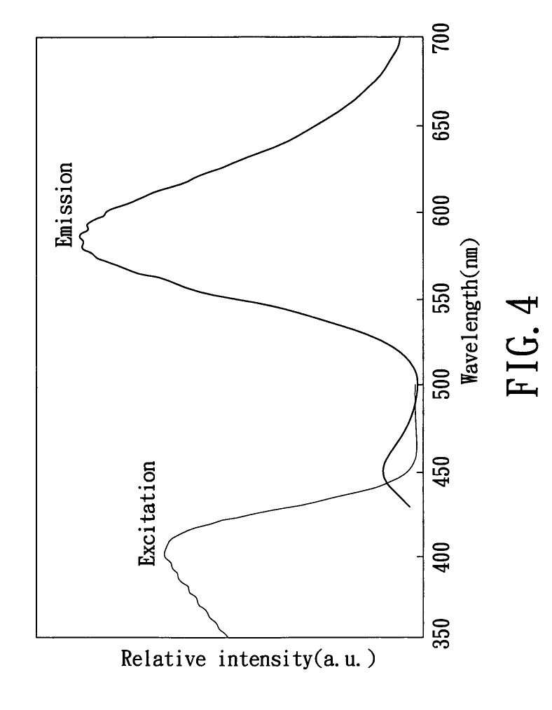

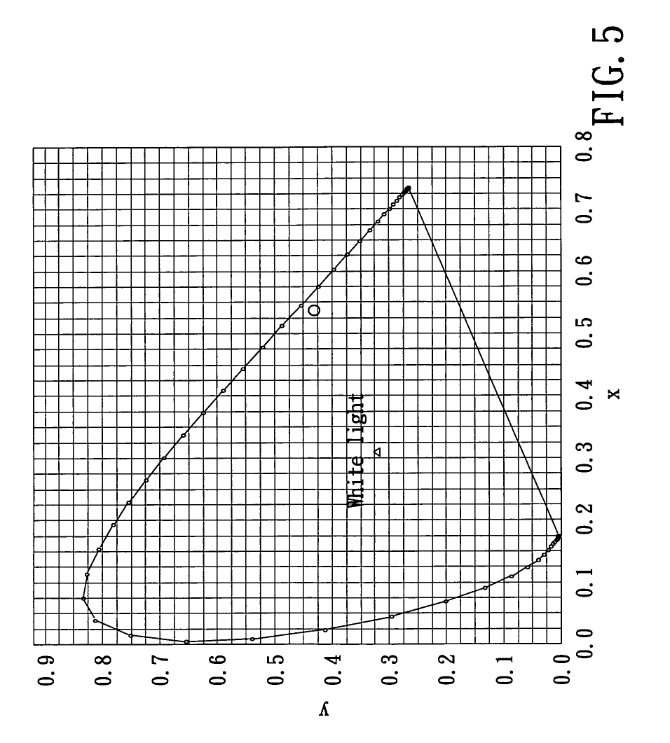

Referring to FIG. 4, the second fluorescent material (Ca,Eu,Mn)(PO₄)₃Cl can be excited by ultraviolet light and radiate orange light with 590 nm wavelength. The light emission spectrum of the second fluorescent material (Ca,Eu,Mn)(PO₄)₃Cl is represented with color coordinate points x and y in a C.I.E chromaticity diagram as shown in FIG. 5.

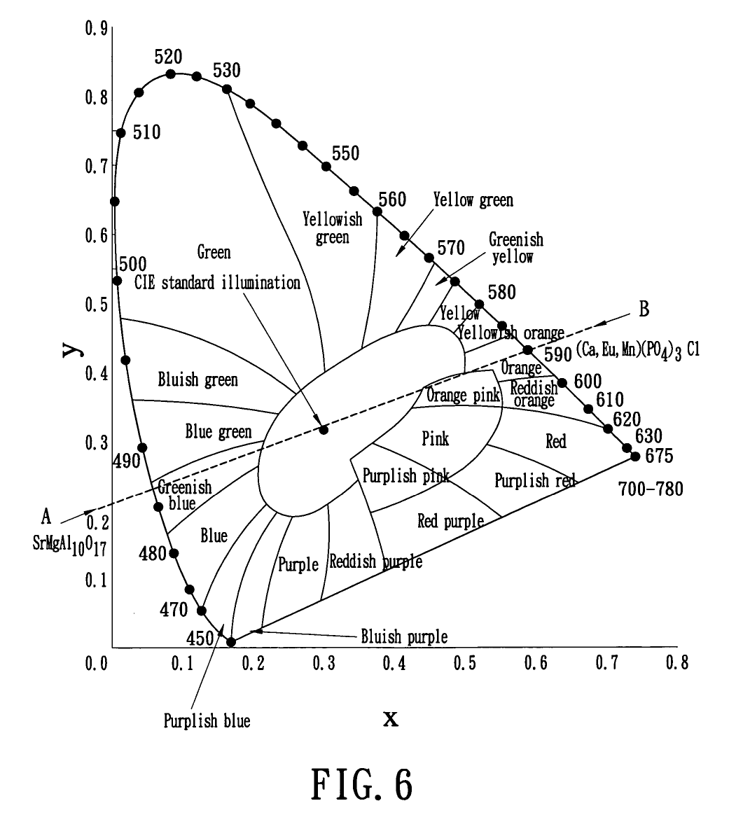

Referring to FIG. 6, the corresponding color coordinate points of the first and the second fluorescent powders are connected together and marked with a dashed line in a chromaticity diagram. This dashed line passes through a white region of the chromaticity diagram, i.e., an observer can perceive the combination of the blue-green light radiated from the first fluorescent powder (Ba_{1-x-y}EuₓSr_{y})MgAl₁₀O₁₇ and the orange light emitted from the second fluorescent powder (Ca,Eu,Mn)(PO₄)₃Cl as white light. Therefore, the white light illumination device of the present invention can be obtained by blending the first and the second fluorescent powders prepared by the manufacturing method of the present invention, using a light-emitting diode capable of emitting ultraviolet light as an excitation light source, and applying a driving current after encapsulating.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A white light illumination device, comprising:
a light-emitting diode capable of emitting ultraviolet light;
a first fluorescent powder excited by the ultraviolet light from the light-emitting diode and emitting blue-green fluorescent light having a peak emission wavelength of about 470 to about 500 nm, a chemical formula of the first fluorescent powder being (Ba_{1-x-y}EuₓSr_{y})MgAl₁₀O₁₇, where 0<x≦1, 0≦y≦1; and
a second fluorescent powder being excited by the ultraviolet light from the light-emitting diode and emitting orange fluorescent light having a peak emission wavelength of about 570 to about 600 nm, a chemical formula of the second fluorescent powder being (Ca,Eu,Mn)(PO₄)₃Cl;
wherein the blue-green and the orange fluorescent lights combine to produce white light.

2. The white light illumination device as claimed in claim 1, wherein one of plasma and an electron beam is used to generate the ultraviolet light.

3. The white light illumination device as claimed in claim 1, wherein the white light illumination device is obtained by blending the first and the second fluorescent powders, using the light-emitting diode capable of emitting ultraviolet light as an excitation light source, and applying a driving current after encapsulating.

4. The white light illumination device as claimed in claim 1, wherein the first fluorescent powder comprises substituting metallic ions with different ion radii to change a light emission wavelength thereof.

5. A method for producing a white light lamination device, comprising: providing an ultraviolet light source; synthesizing a first fluorescent powder, wherein the first fluorescent powder emits a blue-green light having a peak wavelength of about 470 to about 500 nm by excitation with ultraviolet light emitted from the ultraviolet light source, a chemical formula of the first fluorescent powder being (Ba_{1-x-y}EuₓSr_{y})MgAl₁₀O₁₇ where 0<x≦1, 0≦y≦1;
synthesizing a second fluorescent powder, wherein the second fluorescent powder emits an orange light having a peak wavelength of about 570 to about 600 nm by excitation with ultraviolet light emitted from the ultraviolet light source, a chemical formula of the second fluorescent powder being (Ca,Eu,Mn)(PO₄)₃Cl; and
blending the first and second fluorescent powders in predetermined proportions.

6. The method for producing a white light lamination device as claimed in claim 5, wherein one of plasma and an electron beam is used to generate the ultraviolet light.

7. The method for producing a white light lamination device as claimed in claim 5, wherein the first and the second fluorescent powders are made by one of a citrate gel method and a co-precipitation method.

8. The method for producing a white light lamination device as claimed in claim 5, wherein the first fluorescent powder comprises substituting metallic ions with different ion radii to change a light emission wavelength thereof.
